(19) United States
(12) Patent Application Publication
(10) Pub. No.: US 2009/0274141 A1
(43) Pub. Date: Nov. 5, 2009

(54) IP TELEPHONE SYSTEM AND IP TELEPHONE METHOD

(75) Inventor: Takeo Kanai, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: SOFTBANK BB CORP, TOKYO (JP)

(21) Appl. No.: 11/910,507

(22) PCT Filed: Apr. 3, 2006
(86) PCT No.: PCT/JP2006/307070

§ 371 Date: Oct. 2, 2007

(30) Foreign Application Priority Data
Apr. 4, 2005 (JP) 2005-108041

(51) Int. Cl. H04L 12/66

(52) U.S. Cl. 370/352

(57) ABSTRACT

There are provided an IP telephone system and method for establishing a connection to the IP network 4 via a public line network and performing talking by transmitting/receiving IP packet data into which audio data has been converted. In a location server 3 arranged on a PSTN 5 or the IP network 4, a public line telephone number and an IP telephone number which are attached to the line connected to a telephone terminal 1a and a terminal identifier identifying the telephone terminal 1a are registered while correlating them to each other. When an IVR 8 is called, the public line telephone number, the IP telephone number of the telephone terminal 1a and/or the terminal identifier is acquired from the telephone terminal 1a and the registration content in the location server 3 is modified via a registrar system 7.

### TECHNICAL FIELD

The present invention relates to an IP telephone system and an IP telephone method of the so-called IP telephony in which, even if the communication terminal the user uses is moved to another location, the user can use an IP telephone through another communication line.

### BACKGROUND ART

In the past, the communication equipment become more multifaceted, including cellular phones, mobile terminals and so forth, such that an individual makes use of a plurality of communication devices. Particularly, in recent years, the rapid spread of broadband makes it possible to transmit and receive audio data through a high speed communication line having a large capacity. IP telephone terminals enabling a voice conversation by the use of an IP network are getting so much attention (for example, refer to Patent Document 1).

In the IP telephony, each IP telephone terminal is given an IP telephone number (for example, “050- . . . ”), which is bound to a telephone number of a public telephone network, called an OAB-J number such as 03- . . . . The IP telephone terminal connected to a call agent on the Internet by the use of this IP telephone number. The call agent enables transmission and reception of audio data, which is converted into IP packet data, between the caller and the callee on the basis of an IP address, a MAC address and the like bound to the IP telephone number.

### Patent Document 1:

Japanese Patent Published Application No. 2003-250005

### SUMMARY OF THE INVENTION

However, in the case of conventional IP telephones, there is a problem in that since IP telephone numbers are bound to telephone numbers of a public telephone network as described above, for example, when the user is moved due to the change of residence or the like so that the location where the user uses the communication terminal is changed as well as the public telephone network the user uses, the user can no longer use his IP telephone number and has to acquire a new IP telephone number. Also, even when the user has temporarily moved, there is the desire of the user to use the IP telephone number he uses on a routine basis without acquiring a new IP telephone number.

The present invention has been made in the circumstances as described above, and it is an object of the present invention to provide an IP telephone system and an IP telephone method for making a telephone conversation by transmitting and receiving audio data in the form of IP packet data in which, even if the location of the terminal used by the user is changed, the same IP telephone number can be used.

In order to accomplish the object as described above, the present invention provides an IP telephone method for making a telephone conversation by connecting to an IP network through a public telephone network and transmitting and receiving IP packet data obtained by converting audio data, comprising: in a location server located in the public telephone network or the IP network, registering in association with each other a public line telephone number of the public telephone network and an IP telephone number which are assigned to a telephone terminal connected to the public telephone network, and a terminal identifier which can be used to identify the telephone terminal; in a voice response unit located in the public telephone network, acquiring, from the telephone terminal, the public line telephone number, IP telephone number and/or terminal identifier of the telephone terminal by transmitting and receiving audio signals between the voice response unit and the telephone terminal; and changing registration content in the location server with respect to the public line telephone number, IP telephone number and/or terminal identifier of the telephone terminal which are acquired by the voice response unit.

Incidentally, in relation to the present invention, the public line telephone number is the number assigned to a subscriber fixed-line telephone, i.e., the so-called OAB-J type number, starting from “0” followed by nine digits, and the IP telephone number is the number for the IP telephony starting from “050” or a OAB-J type number satisfying predetermined requirements. Also, in relation to the present invention, the terminal identifier is an identifier unique to each terminal or each user, for example, including a MAC address, an IP address, a SIP-URL, a user ID and a password.

In accordance with the present invention as described above, the public line telephone number, IP telephone number or terminal identifier of each user are associated with each other and generally registered in the location server, and the registration information is timely updated by calling the voice response unit in order to conform to the communication line to which the telephone terminal is currently connected. Thereby, even if the user moves, the IP telephone number and the like is bound to the public line telephone number available after moving, and the user can continue to use the same IP telephone number.

In the above invention, it is preferred to perform the process of, when the telephone terminal is called, notifying the location server of the IP telephone number of the callee of the calling process, and acquiring the public line telephone number, IP telephone number and/or terminal identifier of the telephone terminal depending upon whether or not the telephone terminal is to be connected to the IP network or depending upon the change of the connection state therebetween; and performing switch connection of the communication between the telephone terminal of the callee of the calling process and the telephone terminal of the caller of the calling process on the basis of the public line telephone number, IP telephone number and/or terminal identifier of the telephone terminal which are acquired.

In this case, even if the user moves, the IP telephone number and the like are bound to the public line telephone number available after moving in the location server, and thereby irrespective of the location of the callee user the same IP telephone number can be continuously to used by interrogating the location server during switch connection to establish the communication.

In the above invention, it is preferred to perform the process of storing an IP telephone number and/or a terminal identifier assigned to the telephone terminal in a terminal information storage unit provided in the telephone terminal or a terminal equipment provided on the telephone terminal side; acquiring the public line telephone number of the public telephone network by a line information acquisition unit located in the public telephone network to which the telephone terminal is connected; and reading the public line telephone number, IP telephone number and/or terminal identifier of said telephone terminal from said terminal information storage unit and said line information acquisition unit by the change registration unit, and changing said registration content.

In this case, the registration process can be automatically performed in the location server by the telephone terminal or the terminal equipment, and thereby the user can update the above registration content only by moving the telephone terminal or the terminal equipment without a need for particular operation.

In this case, it is preferred that the change registration unit receives a manipulation signal or an audio signal from the telephone terminal, acquiring the public line telephone number, IP telephone number and/or terminal identifier as identified by the signal, and performing the change of the registration content.

In this case, for example, by the use of reception of a signal generated by manipulation of buttons or the recognition of voice audio signals, the user can manually transmit necessary information to the location server and update the above registration content without moving the telephone terminal and the terminal equipment.

### BRIEF DESCRIPTION OF THE DRAWINGS

FIG. 1 is a view for schematically showing the configuration of an IP telephone system in accordance with an embodiment.

FIG. 2 is a block diagram showing the internal configurations of the respective devices in accordance with the embodiment.

FIG. 3 is an explanatory view for showing the operation (automatic registration) of the IP telephone system in accordance with the embodiment in the case where the user moves.

FIG. 3 is an explanatory view for showing the operation (manual registration) of the IP telephone system in accordance with the embodiment in the case where the user moves.

FIG. 5 is a flow chart for showing the operation (automatic registration) of the IP telephone system in accordance with the embodiment in the case where the user moves.

FIG. 6 is a flow chart for showing the operation (manual registration) of the IP telephone system in accordance with the embodiment in the case where the user moves.

FIG. 7 is a flow chart for showing the call process of the IP telephone system in accordance with the embodiment.

### BEST MODE FOR CARRYING OUT THE INVENTION

In what follows, a preferred embodiment of the present invention will be explained with reference to the drawing.

(IP Telephone System)

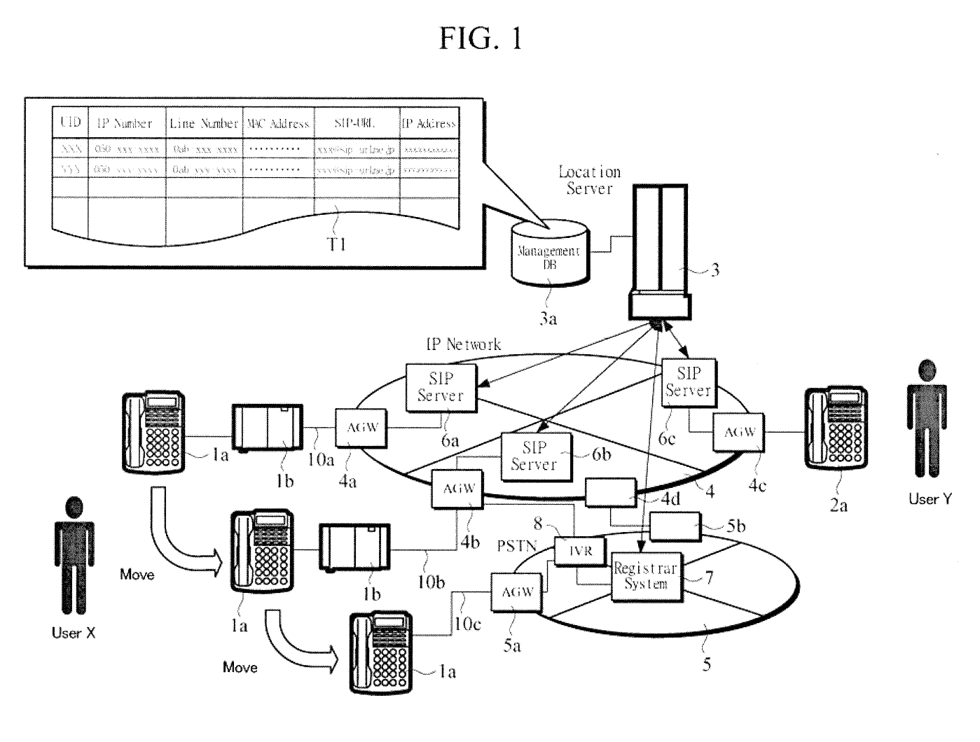

FIG. 1 is a view for schematically showing the configuration of an IP telephone system in accordance with the present embodiment. Incidentally, the term “module” stands for a function unit capable of performing a predetermined operation and implemented with hardware such as a device or apparatus, software capable of performing the functionality as required, or a combination thereof.

The communication network of the present embodiment is constructed mainly by an IP network 4 and PSTN (Public Switched Telephone Network) 5. The IP network 4 and the PSTN 5 are connected with each other through gateways 4d and 5b. Meanwhile, in the case of the present embodiment, an example will be explained with respect to the case that one user X uses the telephone terminal 1a to make a telephone conversation with another user (for example, the user Y) who uses a telephone terminal 2a.

The IP network 4 is a distributed communication network which is constructed by connecting a variety of communication lines (telephone line, ISDN line, public network such as ADSL line, dedicated communication line, and radio communication network) to each other by the use of the communication protocol TCP/IP. This IP network 4 may be a LAN such as an intranet (a network within a company) based on 10BASE-T, 100BASE-TX or the like. The PSTN 5 is a communication network of a usual subscriber telephone network. The telephone terminal 1a can be connected to the telephone terminal 2a through a circuit switching system in order to enable a voice conversation therebetween. In addition to this, the above gateways 4d and 5b are apparatuses located in the respective networks for enabling communication by performing interconversion of data based on different mediums and protocols by absorbing incompatibility relating to communication mediums and transmission schemes.

Various fixed-line telephones are connected to the above communication networks through access gateways (AGW) 4a to 4c and 5a which are installed on these communication networks. In particular, the AGWs 4a to 4c include splitters, switchboards, DSRAMs and the like, and serve as branching stations between the IP network 4 and the PSTN 5 for transferring IP packet data associated with data communication to the IP network 4 and transferring voice signals associated with a voice conversation to the PSTN 5. Particularly, in the case where the IP telephony is not available, these AGWs 4a to 4c can connect the telephone terminal 1a to the IVR 8 of the PSTN 5 by calling the telephone number assigned to IVR (Interactive Voice Response) 8 and can update connection information registered in a location server 3 through a registrar system 7.

Incidentally, the AGWs 4a to 4c are compatible with IP telephone, and connected to user telephone terminals via broadband lines 1a or 10b such as ADSL. Also, the AGW 5a is a gateway device for a public switched telephone network, and connected to the user telephone terminals via a metallic line 10c.

It is assumed here that the telephone terminal 1a used by the user X is connected to the AGW 4a used before moving through a terminal equipment 1b. The terminal equipment 1b is a device for connecting the telephone terminal 1a to the IP network 4, and includes a modulator demodulator device such as a modem for converting digital data into an audio signal and vice versa when connecting to a telephone line, a signal conversion device such as an ADSL modem for converting an ADSL signal into a LAN signal and vice versa when connecting to an ADSL line, a DSU and a terminal adapter which is required for connecting to an ISDN line, and so forth.

Several SIP servers 6a to 6c are located in the IP network 4. Each of these SIP servers 6a to 6c is a call control device which operates, when providing an IP telephone service on the IP network 4, such that the IP network 4 is used as a transit switch. More specifically speaking, during performing switch connection, each of these SIP servers 6a to 6c accesses a data table in which user IDs, passwords, SIP-URLs, telephone numbers (public line telephone numbers or IP phone numbers) are associated with terminal identifiers such as IP addresses, the MAC addresses and the like, searches the data table for the respective IP addresses of the caller and callee, and establishes communication therebetween through the transmission and reception of IP packets.

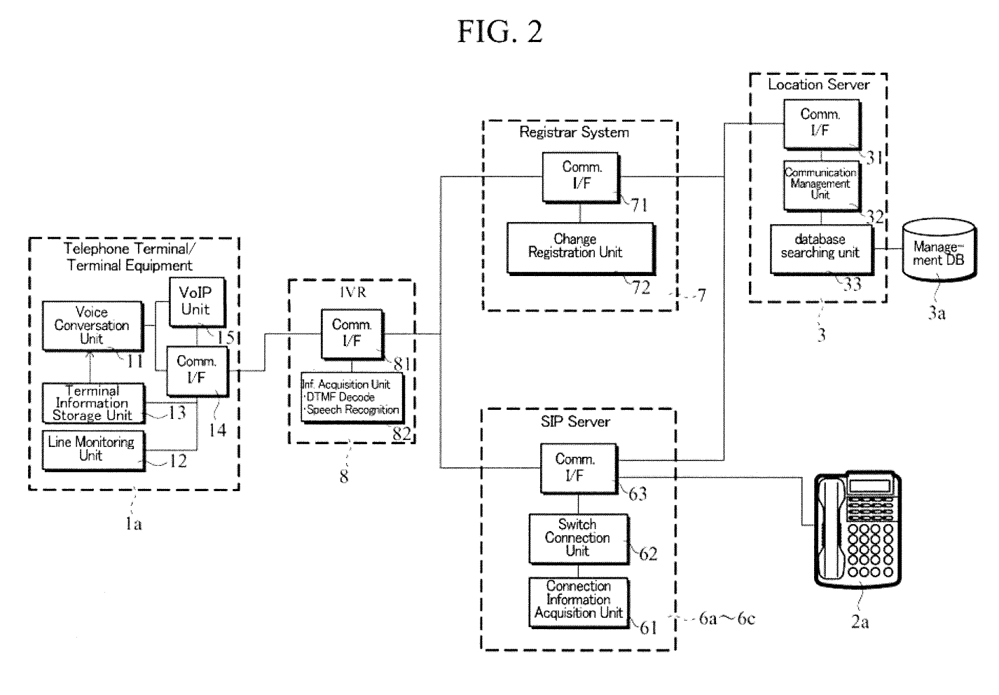

Next, the internal configuration of the respective devices of the above system will be explained. FIG. 2 is a block diagram showing the internal configuration of the respective devices.

Specifically, the telephone terminal 1a is provided with a voice conversation unit 11, a line monitoring unit 12, a terminal information storage unit 13, a communication I/F 14 and a VoIP unit 15. Meanwhile, in the explanation of this example, it is assumed that the respective modules 11 to 15 are provided within the telephone terminal 1a. However, the respective modules may be installed in the terminal equipment 1b or distributed between the telephone terminal 1a and the terminal equipment 1b.

The voice conversation unit 11 is a module for performing an ordinary telephone conversation by transmitting and receiving audio signals, and serves to transmit the sound which is input from the microphone of a receiver as an audio signal via the communication line through a communication I/F 14, and output the audio signal, which is received through the communication line, from a speaker of the receiver as an audio signal. In addition, the voice conversation unit 11 is connected to the VOIP unit 15, and if the Internet telephone is available, a telephone conversation can be made through the IP network 4 by transmitting and receiving audio signals in the form of IP packet data through the voice conversation unit 11.

Further, this voice conversation unit 11 is provided with the functionality of transmitting an audio signal called a tone signal or push sound to a DTMF (Dial Tone Multi Frequency) decoder provided in the IVR 8, and also provided with the functionality of reading a terminal identifier stored in the terminal information storage unit 13 and automatically transmitting the terminal identifier as an audio signal. Meanwhile, this terminal information is transmitted in response to a control signal output from the line monitoring unit 12.

The VoIP unit 15 is a module for implementing the Internet telephony by VoIP functions. The VOIP functions includes the functions of converting the audio signal input from the voice conversation unit 11 into IP packet data, transmitting the IP packet data to the terminal of the intended recipient, converting the IP packet data as received from the terminal of the intended recipient into the audio signal, and inputting the audio signal to the voice conversation unit 11, and therefore it is possible to make a telephone conversation with the telephone terminal 2a on the IP network 4 or a fixed-line telephone (not shown in the figure) on the PSTN 5. Furthermore, while performing the transmission and reception of IP packets on the basis of the IP address (or SIP ID) assigned to the telephone terminal 1a by a DHCP server on the IP network 4, the VOIP unit 15 is also provided with the functionality of storing the IP address (or SIP ID) as assigned in the terminal information storage unit 13, and notifying the IVR 8 of the IP address (or SIP ID) when necessary.

The line monitoring unit 12 is a module for monitoring the line connection state. More specifically speaking, a control signal is transmitted to a predetermined SIP server located in the IP network 4 periodically or when the system starts. The line monitoring unit 12 monitors the signal returned in response to this control signal to detect whether or not the SIP server is connectable. If no response signal is detected, it is determined that the line connection state is changed, followed by determining whether the IP network 4 is connectable and whether only the PSTN 5 is connectable.

The terminal information storage unit 13 is a storage device such as a memory device which stores terminal identifiers which are needed for identifying the telephone terminal 1a and the user X and transmits the identifiers through the voice conversation unit 11 in response to a request from a SIP server or the location server. More specifically speaking, this terminal information storage unit 13 stores, as terminal identifiers (user identifiers), IP telephone numbers beginning with “050”, OAB-J type numbers satisfying predetermined requirements, identifiers unique to each terminal and user such as the MAC addresses, IP addresses and the like including SIP-URLs, user IDs, passwords.

The IVR 8 is a computer system which performs interactive voice response, and serves as a module for receiving an operation signal output in response to dial or push operation by the caller, and automatically playback, on the caller side, a message sound which is recorded in advance in response to the operation signal.

More specifically speaking, this IVR 8 includes a communication I/F 81 for enabling communication connection through audio signals, and an information acquisition unit 82 which acquires a terminal identifier transmitted from the telephone terminal 1a through DTMF, and a public line telephone number, which are assigned to the telephone terminal 1a, of the public line through which the telephone terminal 1a calls the IVR 8.

Namely, this information acquisition unit 82 is provided with a DTMF decoder which decodes an audio signal such as a push tone or a tone signal which is transmitted from the telephone terminal, in order to automatically receive a terminal identifier such as a SIP ID or the MAC address from the telephone terminal. In addition, the information acquisition unit 82 acquires the public line telephone number of the subscriber line connected to the IVR 8, and transmits this public line telephone number to the registrar system 7 as information for identifying the telephone terminal and the user. Furthermore, the information acquisition unit 82 is provided with a speech recognition feature which makes it possible to acquire connection information (public line telephone number, IP telephone number or terminal identifier) which is determined in accordance with an audio signal of user's speech.

Meanwhile, in the case where a single global IP address is shared by a plurality of telephone terminals, for example, through NAT (Network Address Translation) over which the telephone terminal 1a is set up in a LAN of a company, this IVR 8 acquires as a terminal identifier the last-used IP address (which is assigned when connected) and the telephone number after moving.

On the other hand, the SIP servers 6a to 6c are provided with a communication I/F 63 and a switch connection unit 62 serving as the call control device as described above. Also, while unique server addresses are assigned to these SIP servers 6a to 6c respectively, the telephone terminal 1a or 2a accesses the SIP server identified by a server address, performs an authentication process by transmitting a user ID and a password to enable the IP telephony. The SIP servers 6a to 6c relay IP packets to be transmitted and received on the basis of the terminal identifiers (MAC address and IP address) of the authenticated telephone terminal and the terminal identifiers of the telephone terminal of the intended recipient in order to establish a voice conversation through the IP network 4.

Furthermore, the SIP servers 6a to 6c are provided with a connection information acquisition unit 61 for cooperation with the location server 3. This connection information acquisition unit 61 is a module which, when the telephone terminal 1a is called, notifies the location server 3 of the IP telephone number of the telephone terminal 1a, and acquires the connection information (public line telephone number, IP telephone number or terminal identifier) of the telephone terminal 1a from the location server 3 depending upon the change of the line connection state or whether or not the telephone terminal 1a is to be connected to the IP network 4. In this case, whether or not the telephone terminal 1a is to be connected to the IP network 4 is determined by determining whether the call process relates to the telephone conversation within the same IP telephone service or determining whether an IP telephone conversation possible.

The switch connection unit 62 performs an ordinary switch connection process if the caller and the callee are located within the same network (the same communication service), or alternatively, when the ordinary switch connection process cannot be performed, for example, when the telephone terminal 1a and the user X move resulting in changing the line telephone number, the switch connection unit 62 performs another switch connection process for communication between the telephone terminals of the callee and caller relating to the call process on the basis of the public line telephone numbers, IP telephone numbers and terminal identifiers of the telephone terminals (of the callee and caller) obtained by the connection information acquisition unit 61.

Incidentally, the registrar system 7 shown in FIG. 1 is a system which is located in the PSTN 5 and provided with an change registration unit 72, and serves to acquire connection information from the telephone terminal 1a through the IVR 8, and register the information as acquired (or update the registration content) in the location server 3.

Specifically, the change registration unit 72 is a module for communicating with the IVR 8 on the basis of a predetermined protocol, and transmitting and receiving necessary data, and serves to read the public line telephone number, IP telephone number or terminal identifier of the telephone terminal 1a from the terminal information storage unit 13 and the information acquisition unit 82.

The location server 3 is a server which registers and manages, for each user, the communication line used by the user for connection or the SIP server the user belongs to, and is connected to the respective SIP servers on the communication network to manage the information about the user on the basis of the information notified by the SIP servers and the registrar system.

More specifically speaking, the location server 3 is provided with a user management database 3a, which stores a data table TI accumulating IP networks, public line telephone numbers, MAC addresses, SIP-URLs (including server address), IP addresses, and the like required for switching connection. The IP addresses shown in the data table T1 may be global IP addresses which are uniquely assigned to the respective IP telephone terminals, and the global IP addresses may be used for searching the telephone number after moving.

Also, the location server 3 is provided with a communication path management unit 32 and a database searching unit 33, and serves to acquire the changes notified by the SIP servers 6a to 6c and the registrar system 7 followed by updating the user management database 3a, returns the connection information through the communication line, to which the user is currently connected, in response to queries from the SIP servers 6a to 6c and the like.

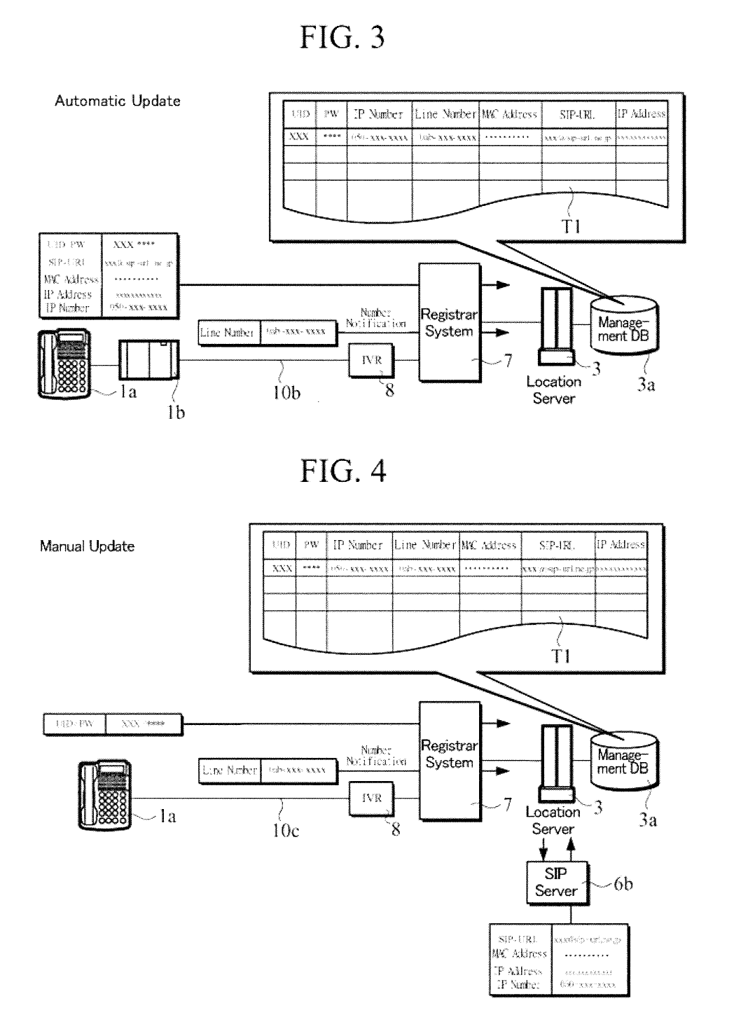

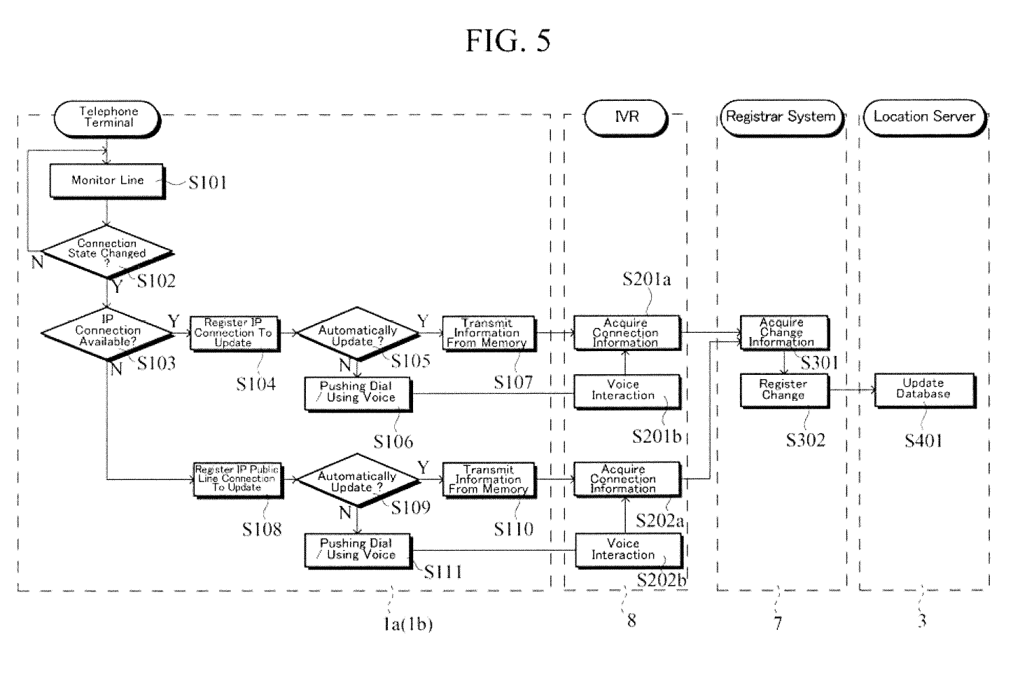

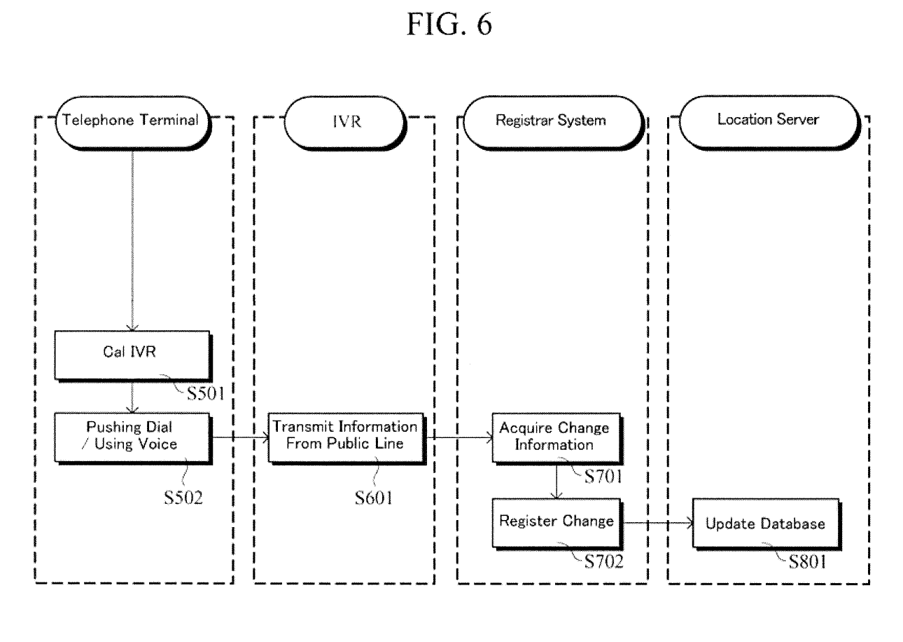

(IP Telephone Method) The IP telephone method in accordance with the present invention can be implemented by operating the IP telephone system having the structure as described above. FIGS. 3 to 5 are explanatory views and a flow chart for showing the operation of the IP telephone system in accordance with the present embodiment in the case where the user moves. Meanwhile, in this case, it is assumed that the user registration of the respective users and the registration of the telephone numbers and the like of a plurality of communication terminals (including an IP telephone application) used by the respective users have been completed in the user management database 3a of the location server 3.

It is also assumed that the user X is about to move and then make a telephone conversation by the use of another communication line. There are two forms of the moving of the user X, i.e., that the user X moves with the telephone 12/24 terminal 1a, for example, in the case of change of the residence, and that the user X moves alone and makes use of a telephone terminal installed in the location after moving.

When moving with the telephone terminal 1a, the user X can easily change the registration content by automatically notifying the location server 3 of the connection information stored in the terminal information storage unit 13 provided in the telephone terminal 1a. On the other hand, when the user X moves alone, he has to manually input necessary information by interactive operation of the IVR 8.

With respect to the type of the communication line available after moving, there are two forms of the moving, i.e., moving to another IP network and moving to a PSTN. In the case of moving to another IP network, since the IP telephony is available even after moving, the information required for the IP telephony has to be registered in the location server 3. In the case of moving to a PSTN, since the IP telephony is not available after moving, the information indicative of this fact has to be registered in the location server 3 (i.e., the registration of only the public line telephone number and the deletion of the other information (MAC address, IP address and the like) as well as the information required for enabling the connection to the public telephone line.

(1) User Moves with Telephone Terminal

First, an example will be explained with respect to the case that the user moves with a telephone terminal. As illustrated in FIG. 3, when moving with the telephone terminal, it is possible to perform the process of changing the registration content in the location server 3 by the use of an automatic updating function provided in the telephone terminal. Meanwhile, even in this case, the changing process may be manually performed if the user desires or depending upon the condition of the network.

It is assumed here that the user X has moved to another location where the telephone terminal 1a is connected to a telephone line on this another location. The line monitoring unit 12 of the telephone terminal 1a transmits a control signal to a predetermined SIP server located in the IP network 4 periodically or when the system starts, and monitors the signal returned in response to this control signal to detect whether or not the SIP server is connectable in steps S101 and S102.

Then, in step S102, if the response signal is returned (i.e., the “N” branch from step S102), it is determined that the communication function is continuously available and the current state is maintained while continuously monitoring the line connection state. On the other hand, if the response signal is not returned (i.e., the “Y” branch from step S102), it is determined that the line connection state is changed, followed by determining in step S103 whether the IP network 4 is connectable (whether broadband connection is available).

In step S103, if it is determined that the IP connection is available (i.e., the “Y” branch from step S103), the process of updating the registration content is started to use the IP communication line (an IP telephone number such as “050” is available) in step S104. First is the process of calling and connecting to the IVR 8 on the PSTN 5. The user then selects the manual operation by himself or the automatic updating function which is provided in the telephone terminal 1a in step S105. If the automatic updating function is selected (i.e., the “Y” branch from step S105), the IVR 8 transmits the connection information acquired from the terminal information storage unit 13 and the information acquisition unit 82 to the change registration unit 72 of the registrar system 7 in steps S107 and S201a. Meanwhile, in this case, if the user moves only within the same service, it is possible to search for the IP telephone number, for example, only on the basis of the terminal identifier such as a MAC address, and thereby unnecessary information need not be transmitted.

If the manual operation is selected for updating in step S105, the IVR 8 is called and starts voice interaction in accordance with which necessary information is transmitted to the IVR 8 by pushing dial keys or using voice in steps S106 and S201b. For example, in the case of such manual updating, while inputting no terminal information, only a user ID, a password and an IP telephone number may be input to the IVR 8, and other information (MAC address and the like) is acquired by interrogating the appropriate SIP server through the registrar system 7 and the location server 3 on the basis of the user ID, the password and the like.

On the other hand, in step S103, if it is determined that the IP connection is not available (i.e., the “N” branch from step S103), the registration content is updated in step S108 to use the public telephone line (only a OAB-J type number is available) . Namely, after calling and connecting to the IVR 8 on the PSTN 5, the user selects the manual operation by himself or the automatic updating function which is provided in the telephone terminal 1a in step S109. If the automatic updating function is selected (i.e., the “Y” branch from step S109), the IVR 8 transmits the connection information acquired from the terminal information storage unit 13 and the information acquisition unit 82 to the change registration unit 72 of the registrar system 7 in steps S110 and S202a. Incidentally, in the same manner as described above, if the manual operation is selected for updating in step S109, necessary information is transmitted in accordance with voice interaction in steps S111 and S202b.

The IVR 8 notifies the registrar system 7 of the connection information change after moving which is acquired as discussed above, and the registrar system 7 updates the user management database 3a of the location server 3 on the basis of the notification in step S301, S302 and S401. Namely, when the IP telephony is available after moving, the public line telephone number available in the location after moving and the terminal identifier such as the MAC address are registered for updating. When the IP telephony is not available after moving, only the public line telephone number available in the location after moving is registered while deleting the information required only for the IP telephony such as the terminal identifier.

(2) Only User Moves

Next, an example will be explained with respect to the case that the user moves alone, and that it is enabled to accept an incoming call at the IP telephone number, which has been used before moving, by the use of a telephone terminal installed in the location after moving. As illustrated in FIG. 4, in order to make available the telephone terminal (given reference 1a) installed in the location after moving, the minimum of information is transmitted to the registrar system 7 by manual operation, and the location server 3 interrogates the appropriate SIP server on the basis of this information as transmitted, acquires other information and updates the registration content.

First is the process of calling and connecting to the IVR 8 on the PSTN 5 in step S501. Then, in accordance with the guidance of the IVR 8, necessary information is transmitted by pushing dial keys or using voice in step S502. When manually updating in this manner, while inputting no terminal information, for example, only a user ID, a password and an IP telephone number may be input.

In addition to this, the IVR 8 acquires the public line telephone number, which is available after moving and used by the user X, by the use of the caller ID service or the like, and notifies the registrar system 7 of the telephone number as acquired. Incidentally, if the caller ID service of the public telephone line after moving is not available, the telephone number of the public telephone is manually input by the user and transmitted.

The registrar system 7 interrogates the appropriate SIP server (the SIP server to which the user X belongs before moving) by the use of the user ID, the password, the IP telephone number and the public line telephone number, and acquires other information (MAC address, IP address and the like) . Incidentally, in this case, if the IP telephony is not available after moving, the connection information for the IP telephony is not acquired, but only the public line telephone number is acquired as the connection information.

The location server 3 updates the user management database 3a with respect to the connection information after moving as acquired in this manner in step S701, S702 and S801. Namely, when the IP telephony is available after moving, the public line telephone number available in the location after moving and the terminal identifier such as the MAC address are registered for updating. When the IP telephony is not available after moving, only the public line telephone number available in the location after moving is registered while deleting the information such as the terminal identifier required for the IP telephony.

(3) Calling User After Moving

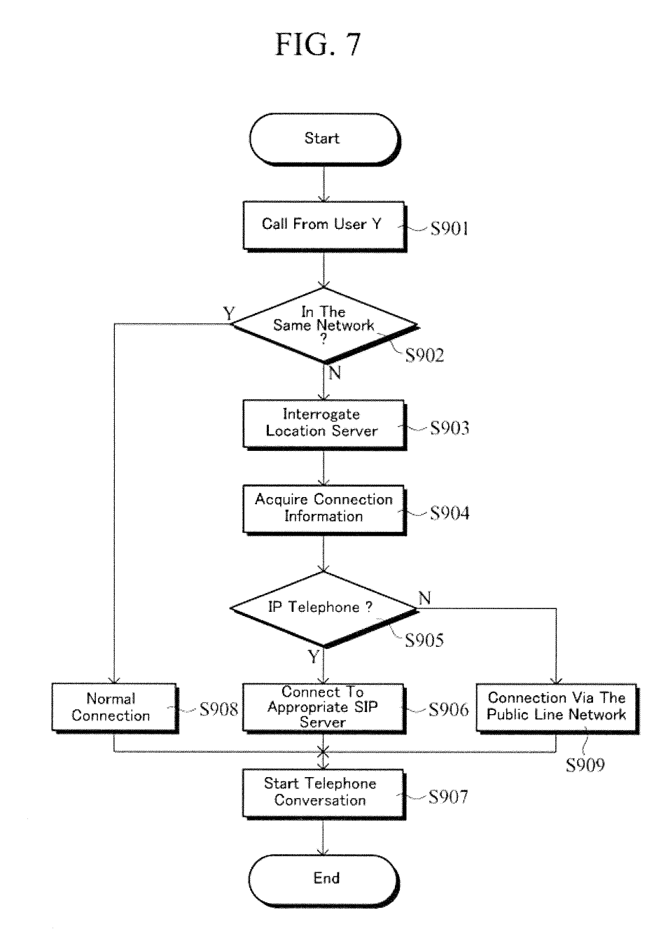

The procedure of calling the user X in the location after moving after changing the registration content in the location server 3 as described above will be explained. FIG. 7 is a flow chart for showing the procedure of calling the user X in the location after moving. Meanwhile, in this case, an example will be explained with respect to the case that the user Y who can use the IP telephony calls.

First, the user Y calls the user X in step S901. In this case, the user Y makes a call at the IP telephone number (“050-xxx-xxxx”) used by the user X before moving. This call is directed to the SIP server 6c to which the user Y belongs, and the switch connection process is started by the SIP server 6c.

The SIP server 6c determines in step S902 whether or not the user X and the user Y are located within the same network (or the same service provided by the same communication company) . If the user X and the user Y are located within the same service (i.e., the “Y” branch from step S902), an ordinary switch connection process is performed only by the use of the connection information stored in the SIP server 6c in step S908.

On the other hand, if the user X and the user Y are not located within the same service (i.e., the “N” branch from step S902), the SIP server 6c interrogates the location server 3. For this interrogation, the SIP server 6c transmits the IP telephone number (“050-xxx-xxxx”) of the user X called by the user Y, and acquires other information which is bound to the IP telephone number (“050-xxx-xxxx”).

Next, this SIP server 6c analyzes the connection information as acquired and selects a connection method in step S905. More specifically speaking, it is determined whether or not the IP telephony is available through the communication line to which the user X is connected in the location after moving. In other words, when the connection information acquired in step S904 is only the public line telephone number (“OAB-xxx-xxxx”) but other information required for the IP telephony (for example, the MAC address and the IP address) is not bound to the public line telephone number, the connection via the public line network (step S909) is selected (i.e., the “N” branch from step S905).

In contrast, when the connection information acquired in step S904 includes the public line telephone number (“OAB-xxx-xxxx”) and other information required for the IP telephony bound to the public line telephone number, the connection via the IP network is selected (i.e., the “Y” branch from step S905). When connecting to this IP network, since the user X can be connected only via another SIP server, the communication is established by connecting to this another SIP server in step S906. By the above procedure, a telephone conversation with the user X in the location after moving can be started in step S907.

(Effects and Advantages of The Present Embodiment)

In accordance with the IP telephone system and method of the present embodiment as explained above, the connection information (public line telephone number, IP telephone number or terminal identifier) of the user X in the location after moving is associated with each other and generally registered in the location server 3, and thereby even if the user X moves the same IP telephone number can be continuously used by interrogating the location server 3.

Also, in the case of the present embodiment, since the connection information required for changing the registration content is stored in the telephone terminal 1a or the terminal equipment 1b, the registration process can be automatically performed in the location server 3, and thereby the user X can update the above registration content only by moving the telephone terminal 1a or the terminal equipment lb without a need for particular operation.

Furthermore, since the IVR 8 is provided, whereas necessary information can be transmitted to the location server 3 by manual operation (or voice interaction), the user X can therefore update the above registration content by manipulating buttons to generate a manipulation signal or using voice to generate an audio signal during updating the registration content without moving the telephone terminal and the terminal equipment.

As a result, in the case of the IP telephony according to the present embodiment, even if the user X moves, the same IP telephone number can be continuously used by registering necessary information (or updating the registration content) required for connection after moving in the location server 3.

### INDUSTRIAL APPLICABILITY

In accordance with the present invention, when making use of the IP telephony for enabling a telephone conversation by transmitting and receiving audio data in the form of IP packet data, even if the location of the terminal used by the user is changed, the same IP telephone number can be used also in the location after moving by registering necessary information (or updating the registration content) required for connection after moving in the location server 3.

What is claimed is:

1. An IP telephone system for making a telephone conversation by connecting to an IP network through a public telephone network and transmitting and receiving IP packet data obtained by converting audio data, said IP telephone system comprising:
a location server located in said public telephone network or said IP network and operable to register, in association with each other, a public line telephone number of said public telephone network and an IP telephone number which are assigned to a telephone terminal connected to said public telephone network, and a terminal identifier which can be used to identify said telephone terminal;
a voice response unit located in said public telephone network and operable to acquire, from said telephone terminal, the public line telephone number, IP telephone number and/or terminal identifier of said telephone terminal by transmitting and receiving audio signals between said voice response unit and said telephone terminal; and
an change registration unit operable to change registration content in said location server with respect to the information acquired by said voice response unit.

2. The IP telephone system as claimed in claim 1 further comprising:
a connection information acquisition unit operable to notify, when said telephone terminal is called, said location server of the IP telephone number of the callee of said calling process, and acquire the public line telephone number, IP telephone number and/or terminal identifier of said telephone terminal depending upon whether or not said telephone terminal is to be connected to said IP network or depending upon the change of the connection state therebetween; and
a switch connection unit operable to perform switch connection of the communication between the telephone terminal of the callee of said calling process and the telephone terminal of the caller of said calling process on the basis of the public line telephone number, IP telephone number and/or terminal identifier of said telephone terminal which are acquired by said connection information acquisition unit.

3. The IP telephone system as claimed in claim 1 further comprising:
a terminal information storage unit provided in said telephone terminal or a terminal equipment provided on said telephone terminal side and operable to store an IP telephone number and/or a terminal identifier assigned to said telephone terminal; and
a line information acquisition unit located in the public telephone network to which said telephone terminal is connected and operable to acquire the public line telephone number of said public telephone network,
wherein said change registration unit has the functionality of reading the public line telephone number, IP telephone number and/or terminal identifier of said telephone terminal from said terminal information storage unit and said line information acquisition unit.

4. The IP telephone system as claimed in claim 1 wherein said change registration unit has the functionality of receiving a manipulation signal or an audio signal from said telephone terminal, and acquiring the public line telephone number, IP telephone number and/or terminal identifier as identified by the signal.

5. An IP telephone method for making a telephone conversation by connecting to an IP network through a public telephone network and transmitting and receiving IP packet data obtained by converting audio data, said IP telephone method comprising:
in a location server located in said public telephone network or said IP network, registering in association with each other a public line telephone number of said public telephone network and an IP telephone number which are assigned to a telephone terminal connected to said public telephone network, and a terminal identifier which can be used to identify said telephone terminal;
in a voice response unit located in said public telephone network, acquiring, from said telephone terminal, the public line telephone number, IP telephone number and/or terminal identifier of said telephone terminal by transmitting and receiving audio signals between said voice response unit and said telephone terminal; and
changing registration content in said location server with respect to the public line telephone number, IP telephone number and/or terminal identifier of said telephone terminal which are acquired by said voice response unit.

6. The IP telephone method as claimed in claim 5 further comprising:
when said telephone terminal is called, notifying said location server of the IP telephone number of the callee of said calling process, and acquiring the public line telephone number, IP telephone number and/or terminal identifier of said telephone terminal depending upon whether or not said telephone terminal is to be connected to said IP network or depending upon the change of the connection state therebetween; and
performing switch connection of the communication between the telephone terminal of the callee of said calling process and the telephone terminal of the caller of said calling process on the basis of the public line telephone number, IP telephone number and/or terminal identifier of said telephone terminal which are acquired.

7. The IP telephone method as claimed in claim 5 further comprising: storing an IP telephone number and/or a terminal identifier assigned to said telephone terminal in a terminal information storage unit provided in said telephone terminal or a terminal equipment provided on said telephone terminal side; acquiring the public line telephone number of said public telephone network by a line information acquisition unit located in the public telephone network to which said telephone terminal is connected; and reading the public line telephone number, IP telephone number and/or terminal identifier of said telephone terminal from said terminal information storage unit and said line information acquisition unit by said change registration unit, and changing said registration content.

8. The IP telephone method as claimed in claim 5 wherein said change registration unit has the functionality of receiving a manipulation signal or an audio signal from said telephone terminal, acquiring the public line telephone number, IP telephone number and/or terminal identifier as identified by the signal, and changing said registration content.
